(19) United States
(12) Patent Application Publication
(10) Pub. No.: US 2019/0213663 A1
(43) Pub. Date: Jul. 11, 2019

(54) VIRTUAL CART OPTIMIZATION TOOL

(71) Applicant: Walmart Apollo, LLC, Bentonville, AR (US)

(72) Inventor: Victor Chowdhury, Bentonville, AR (US)

(21) Appl. No.: 16/237,400

(22) Filed: Dec. 31, 2018

Related U.S. Application Data
(60) Provisional application No. 62/614,193, filed on Jan. 5, 2018.

(51) Int. Cl. G06Q 30/06; G06F 16/2455; G06F 17/27; G06F 16/242; G06F 16/248

(52) U.S. Cl. CPC G06Q 30/0635; G06F 16/24553; G06F 17/2765; G06F 16/248; G06F 16/2425; G06Q 30/0641; G06F 17/272

(57) ABSTRACT

Examples provide a system for real-time virtual cart optimization. A selected target is received for a cart match operation directed at a current cart associated with a host provider via an online selection. One or more items associated with the virtual cart are identified. A targeted query for the selected target is generated using the one or more identified items. The query results are parsed to identify at least two tags, which are used to determine item origination data and item value data. The identified tags are used to calculate per-item differentials, which are used to generate an updated cart.

### BACKGROUND

When shopping online, consumers often visit multiple sites searching for variations in offers for products of interest. Often, this user experience is performed to search for the lowest offer in an effort to obtain the best value for a product. However, a consumer can generally only perform a search for one item at a time, and may also overlook other factors that contribute to the value of an item. In addition, product providers may lose opportunities for consumer interaction based on these overlooked factors or on the multiple site visits that direct a consumer away from the provider's site.

### SUMMARY

Examples of the disclosure provide a system for virtual cart optimization using real-time targeted match operations. A selected target is received for a cart match operation directed at a current cart associated with a host provider via an online selection. One or more items associated with the current cart are identified. A targeted query for the selected target is generated using the one or more identified items. A search engine is queried using the generated targeted query. Query results are received from the search engine, including an individual result for each of the one or more identified items. The received query results are parsed to identify at least two tags, the at least two tags including an item origination tag and an item value tag. For each of the one or more identified items, a determination is made as to whether the item origination tag identifies the selected target or a target other than the selected target. If the item origination tag identifies the target other than the selected target, item origination data is generated. If the item origination tag identifies the selected target, an item value associated with the item value tag is identified. A differential is calculated on a per-item basis using identified item values of at least a subset of items from the one or more identified items. Based on the per-item calculated differentials, an updated cart is generated and output to a user interface.

Other examples provide a computer-implemented method for virtual cart optimization. A real-time targeted match module (RTTMM) implemented on a processor receives a selected target for a cart match operation directed at a current cart associated with a host provider via an online selection. The RTTMM identifies one or more items associated with the current cart, and generates a targeted query for the selected target using the one or more identified items. A search engine is queried using the generated targeted query. Query results are received from the search engine, including an individual result for each of the one or more identified items. The RTTMM parses the received query results to identify at least two tags, the at least two tags including an item origination tag and an item value tag. For each of the one or more identified items, a determination is made as to whether the item origination tag identifies the selected target or a target other than the selected target. If the item origination tag identifies the target other than the selected target, item origination data is generated. If the item origination tag identifies the selected target, an item value associated with the item value tag is identified. The RTTMM calculates a differential on a per-item basis using identified item values of at least a subset of items from the one or more identified items. Based on the per-item calculated differentials, the RTTMM generates an updated cart and outputs the generated updated cart to a user interface.

Still other examples provide one or more computer storage devices for real-time virtual cart optimization. A real-time targeted match module (RTTMM) implemented on a processor receives a selected target for a cart match operation directed at a current cart associated with a host provider via an online selection. The RTTMM identifies one or more items associated with the current cart, and generates a targeted query for the selected target using the one or more identified items. A search engine is queried using the generated targeted query. Query results are received from the search engine, including an individual result for each of the one or more identified items. The RTTMM parses the received query results to identify at least two tags, the at least two tags including an item origination tag and an item value tag. For each of the one or more identified items, a determination is made as to whether the item origination tag identifies the selected target or a target other than the selected target. If the item origination tag identifies the target other than the selected target, item origination data is generated. If the item origination tag identifies the selected target, an item value associated with the item value tag is identified. The RTTMM calculates a differential on a per-item basis using identified item values of at least a subset of items from the one or more identified items. Based on the per-item calculated differentials, the RTTMM generates an updated cart and outputs the generated updated cart to a user interface.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a real-time virtual cart optimization environment.

FIG. 2 is an exemplary block diagram illustrating a virtual cart optimization system.

FIG. 3 is an exemplary block diagram illustrating a real-time targeted match system interface.

FIG. 4 is an exemplary block diagram illustrating an optimized virtual cart.

FIG. 5 is an exemplary block diagram illustrating an RTTMM interface.

FIG. 6 is an exemplary block diagram illustrating an RTTMM interface displaying an optimized virtual cart.

FIG. 7 is an exemplary block diagram illustrating an RTTMM interface displaying an optimized virtual cart.

FIG. 8 is an exemplary flow chart illustrating operation of the cart optimization system to generate an updated cart.

FIG. 9 is an exemplary flow chart illustrating operation of the cart optimization system to iteratively optimize a virtual cart.

Corresponding reference characters indicate corresponding parts throughout the drawings.

### DETAILED DESCRIPTION

Referring to the figures, examples of the disclosure enable a system for real-time cart match operations used to optimize a virtual cart at a host provider site. This online, or virtual, matching tool performs real-time comparison and matching operations with verified selected providers in-cart through the host provider site and automatically updates the virtual cart at the host provider site based on the comparison and matching operation results.

The real-time targeted match module (RTTMM) in some examples analyzes items associated with a current cart at a host provider against obtained targeted query results to generate per-item comparison results and calculate per-item differentials used to dynamically generate an updated cart at the host provider site. This enables the system to provide an optimized cart in real-time with competitive comparison data while maintaining a user experience at the host provider site. This improves the user experience and enables efficient and accurate competitive matching.

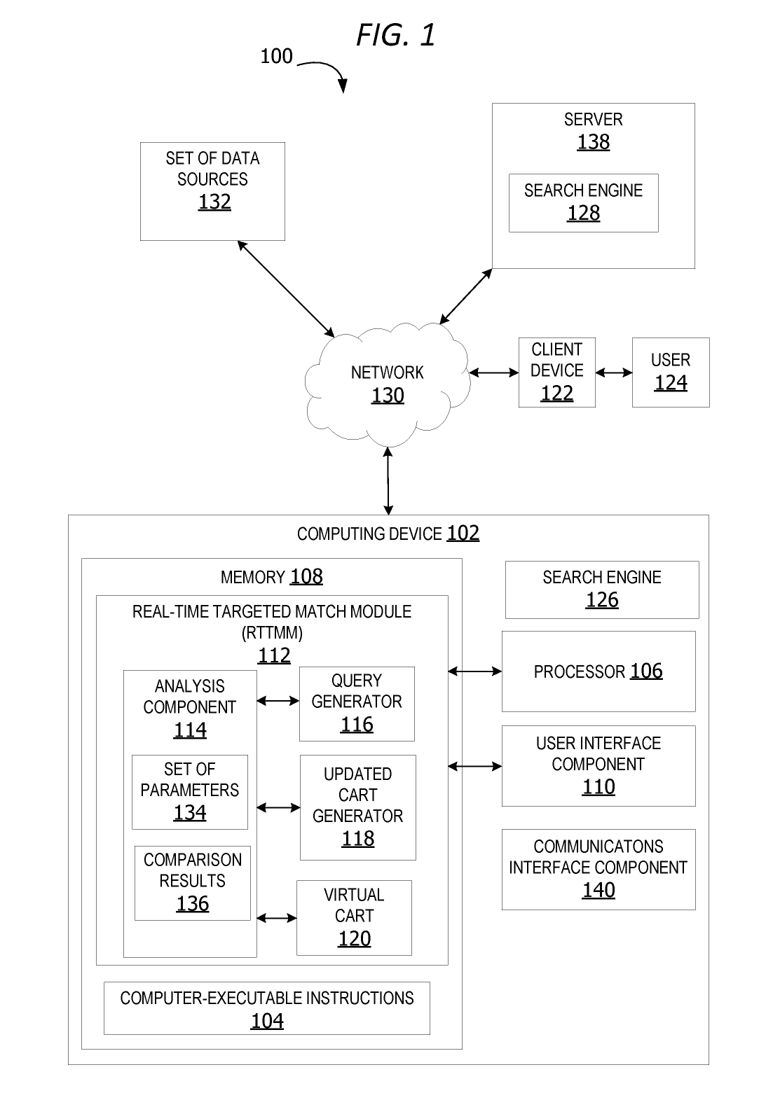

Referring to FIG. 1, an exemplary block diagram illustrates a real-time virtual cart optimization environment 100. In the example of FIG. 1, the computing device 102 represents a system for real-time targeted match operations. The computing device 102 represents any device executing computer-executable instructions 104 (e.g., as application programs, operating system functionality, or both) to implement the operations and functionality associated with the computing device.

Generally, a computing device may include a mobile computing device or any other portable device, such as a mobile telephone, laptop, tablet, computing pad, netbook, gaming device, and/or portable media player. The computing device may also include less portable devices such as desktop personal computers, kiosks, tabletop devices, industrial control devices, wireless charging stations, and electric automobile charging stations. Additionally, the computing device may represent a group of processing units or other computing devices, such as a server or set of servers, or a distributed computing environment that includes any of the above systems or devices.

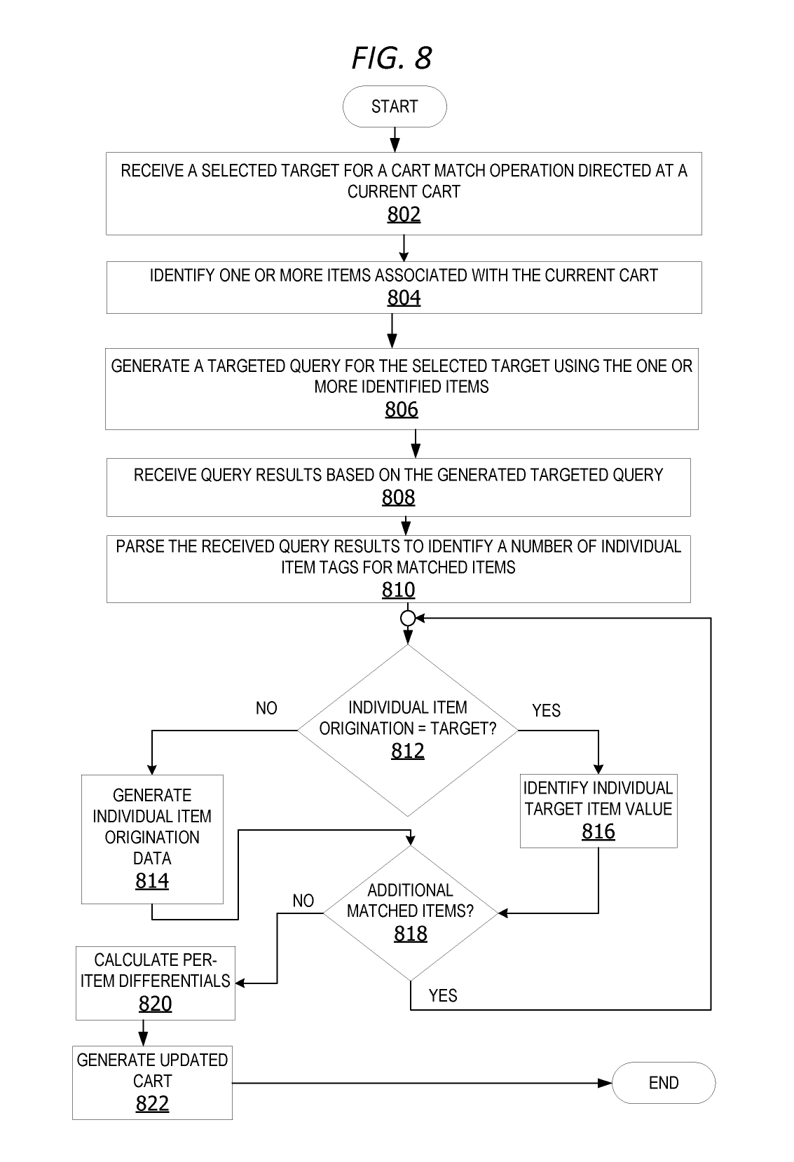

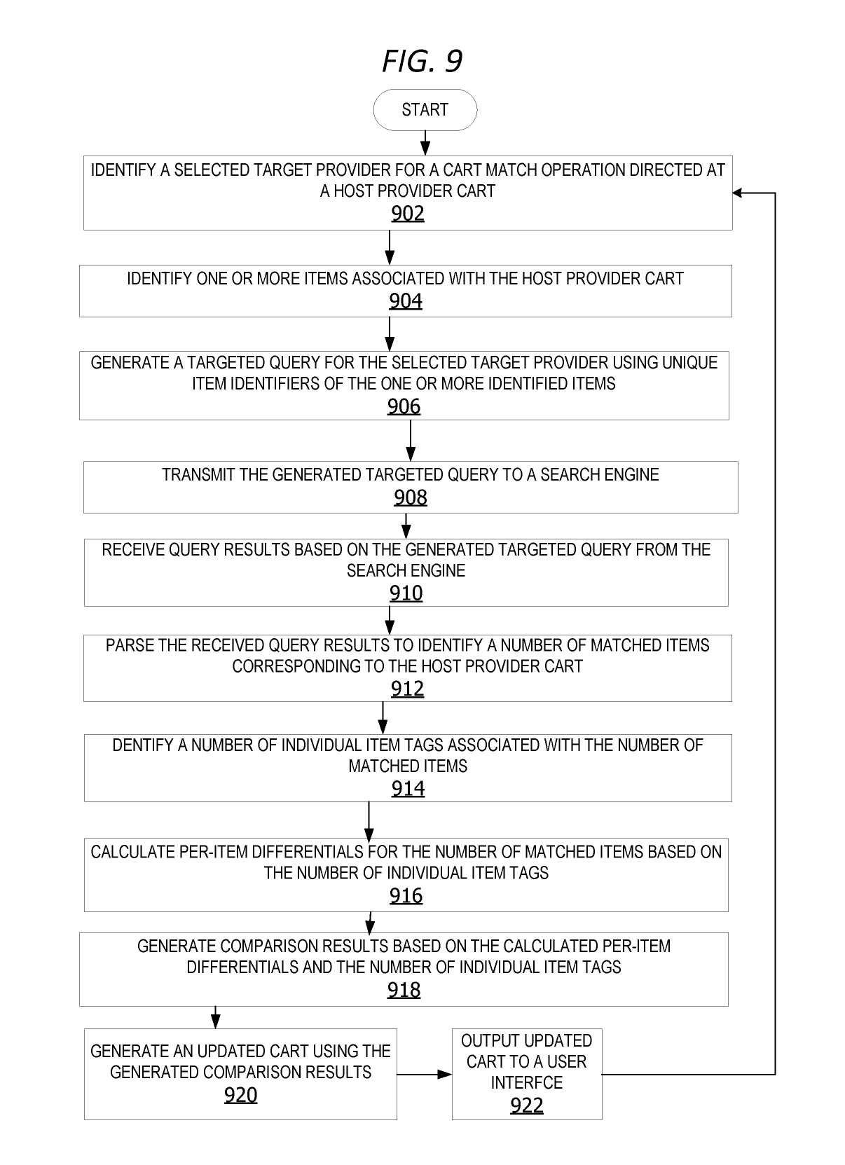

In some examples, the computing device 102 has at least one processor 106, a memory 108, and at least one user interface component 110. The processor 106 includes any quantity of processing units, and is programmed to execute the computer-executable instructions 104 for implementing the real-time targeted match module (RTTMM) 112 of the examples. The computer-executable instructions 104 may be performed by the processor 106 or by multiple processors within the computing device 102, or performed by a processor external to the computing device 102. In some examples, the processor 106 is programmed to execute instructions such as those illustrated in the figures (e.g., FIG. 8 and FIG. 9).

In some examples, the processor represents an implementation of analog techniques to perform the operations described herein. For example, the operations may be performed by an analog computing device and/or a digital computing device.

The computing device 102 further has one or more computer-readable media such as the memory 108. The memory 108 includes any quantity of media associated with or accessible by the computing device 102. The memory 108 may be internal to the computing device (as shown in FIG. 1), external to the computing device (not shown), or both (not shown). In some examples, the memory 108 includes read-only memory and/or memory wired into an analog computing device.

The memory 108 stores data, such as one or more applications. The applications, when executed by the processor, operate to perform functionality on the computing device. The applications may communicate with counterpart applications or services such as web services accessible via a network 130. For example, the applications may represent downloaded client-side applications that correspond to server-side services executing in a cloud.

The network 130 is implemented by one or more physical network components, such as, but without limitation, routers, switches, network interface cards (NICs), and other network devices. The network 130 may be any type of network for enabling communications with remote computing devices, such as, but not limited to, a local area network (LAN), a subnet, a wide area network (WAN), a wireless (Wi-Fi) network, or any other type of network. In this example, the network 130 is a WAN accessible to the public, such as the Internet.

The memory 108 further stores one or more computer-executable components. Exemplary components include RTTMM 112. RTTMM 112 in some examples further includes an analysis component 114, a query generator 116, and an updated cart generator 118.

The RTTMM 112, when executed by processor 106 of the computing device 102, causes the processor to perform real-time virtual cart optimization using comparison and match operations. The RTTMM 112 obtains a virtual cart 120. The virtual cart 120 may be received and/or obtained from a client device 122 via network 130, in some examples. In other examples, virtual cart 120 may be generated at computing device 102 via user interaction by user 124 directly with computing device 102. In still other examples, client device 122 may be an illustrative example of a computing device, such as computing device 102.

The virtual cart 120 may be generated at the client device 122 or computing device 102 via user interaction by user 124 with a host provider site, for example. The analysis component 114 identifies one or more items associated with virtual cart 120 and a selected target corresponding to the virtual cart 120, and provides the identified item data and selected target to query generator 116. The identified item data may include unique item identifiers associated with individual items in the identified items, for example. The selected target may be a target provider selected from a list of pre-defined, or pre-verified, providers. Query generator 116 uses the identified item data and selected target to generate a targeted query.

RTTMM 112 may use a search engine to execute the targeted query and obtain query results. In some examples, computing device 102 may include search engine 126, and RTTMM 112 may provide the targeted query to search engine 126 and receive query results from search engine 126. In other examples, RTTMM 112 may send the targeted query to a remote search engine or network search engine, such as search engine 128. The search engine uses the targeted query provided by RTTMM 112 to search a set of data sources 132 and generate query results that are provided to RTTMM 112. The set of data sources 132 may be sources associated with one or more computing devices and may include, without limitation, target provider internet sites, online sources, databases, or any other suitable data source. In one example, the targeted query may identify a specific data source in the set of data sources 132 for the search, such as a data source associated with the selected target.

The analysis component 114 obtains the received targeted query results, which in some examples may be a set of one or more uniform resource locators (URLs) corresponding to the one or more identified items at the selected target's online site. The analysis component 114 uses the set of one or more URLs returned in the query results to obtain hyper-text markup language (HTML) scripts for each of the one or more URLs. The analysis component 114 parses the individual HTML scripts obtained using set of parameters 134 to identify a number of items and item data, including a number of tags associated with each of the identified items. In some examples, the number of items in the received targeted query results may be a subset of the identified items from the targeted query. In other words, the number of items in the query results may include items that were matched to one or more of the identified items in the targeted query, and may not include one or more of the identified items from the targeted query that were not matched. In other examples, the query results may include an indication of unmatched items, such as a null value or null return corresponding to a particular item of the targeted query. The set of parameters 134 may also include criteria for filtering and/or weighting the identified tags of the parsed HTML scripts. For example, set of parameters 134 may include configurable parameters such as, excluding shipping calculations where specialty or membership-based shipping promotions are identified, filtering out membership-based promotional values, or any other suitable parameter. Analysis component 114 uses set of parameters 134 to process the parsed query results and generate comparison results 136.

Comparison results 136 may include individual item comparison results, such as per-item calculated differentials, per-item origination data, and other per-item data. The updated cart generator 118 uses the comparison results 136 to generate an updated cart for output to a user interface, such as to the requesting client device 122 for example. The updated cart may be an optimized virtual cart, for example.

The user interface component 110 in some examples is implemented on the at least one processor 106 to output the generated updated cart. In other examples, the optimized virtual cart is generated and output by updated cart generator 118 to a user interface component implemented on a processor of client device 122. In some examples, the user interface component includes a graphics card for displaying data to the user and receiving data from the user. The user interface component may also include computer-executable instructions (e.g., a driver) for operating the graphics card. Further, the user interface component may include a display (e.g., a touch screen display or natural user interface) and/or computer-executable instructions (e.g., a driver) for operating the display. The user interface component may also include one or more of the following to provide data to the user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user may input commands or manipulate data by moving the computing device in a particular way.

The client device 122 may trigger the real-time virtual cart optimization via an online retail site or other webpage providing user access to an RTTMM interface associated with a host provider. The RTTMM 112 is hosted on a server, such as computing device 102 in this example. The server may be implemented as any type of computing device for hosting a webpage or website accessible via the network 130, such as, but without limitation, a web server, application server, cloud server, or other host.

In this example, the RTTMM interface and the RTTMM 112 may be located on the computing device 102. In other examples, the RTTMM 112 runs on the computing device 102 and the RTTMM interface runs on server 138. In still other examples, the RTTMM interface and the RTTMM 112 may be executed on a cloud server.

The client device 122 associated with a user 124 represents any device executing instructions (e.g., as application programs, operating system functionality, or both) to implement the operations and functionality associated with the computing device. The client device 122 may include a mobile computing device or any other portable device. In some examples, the mobile computing device includes a mobile telephone, laptop, tablet, computing pad, netbook, gaming device, and/or portable media player. The client device 122 may also include less portable devices such as desktop personal computers, kiosks, tabletop devices, industrial control devices, wireless charging stations, and electric automobile charging stations. Additionally, the client device 122 may represent a group of processing units or other computing devices.

The user 124 utilizes a user interface, such as a web browser, to access the RTTMM interface at a host provider site. The user may select and add one or more items from a list of offered items at the host provider side to the virtual cart and request an in-cart, real-time targeted match operation via the RTTMM interface at the host provider site. The virtual cart may provide an initial per-item description and per-item value designation, along with an initial cart total. The RTTMM interface may be integrated with the virtual cart at the host provider site to provide a targeted match selection option, or targeted comparison selector, with a list of pre-defined or pre-verified target providers. User 124 may select a target provider from the list of targets via the match selection option within the virtual cart, and obtain a real-time, dynamic virtual cart update or optimization within the RTTMM interface at the host provider site. The dynamic virtual cart update, or optimization, may include one or more individual, line-item value adjustments, per-item notifications, and an updated cart total, in some examples.

For example, a virtual cart prior to optimization may include three items selected by the user for addition to the cart. The virtual cart representation may include item description information for each of the three items as well as an item value associated with each of the three items, and a cart total that represents a combined value of the three individual item values as well as any applicable shipping and/or tax values, or other value adjustments. Other value adjustments may include, without limitation, promotional adjustments, membership adjustments, and the like. The integrated RTTMM interface may provide a targeted match option, or comparison selector option, with a list of pre-defined target providers that a comparison and/or match operation may be targeted against. User selection of a target via the targeted match option triggers the RTTMM to perform comparison and match operations directed at the current cart, the virtual cart having the three items selected by the user, and the selected target. The comparison results are used by the RTTMM to generate an updated cart, or optimized cart, output to the RTTMM interface integrated with the virtual cart representation at the host provider site, providing user 124 with a real-time, dynamic virtual cart optimization that includes visual representations and indications of one or more value adjustments and item notification data. In this example, two of the three items in the virtual cart may be associated with adjusted item values, matched against the item value information from the target provider, while the third item may be associated with an item notification indicating the item value from the host provider is the optimal value. In another example, one of the three items may be associated with an adjusted item value, matched against the item value information from the target provider, a second item may be associated with an item notification indicating the item value from the host provider is the optimal value, and a third item may be associated with an item notification indicating the item origination data associated with the target provider is outside the parameters of the match operation.

The online matching tool provided by the RTTMM system matches values with verified top competitors, or target providers, in-cart based on shipped and sold total cost calculations, and automatically updates both individual per-item values as well as a corresponding cart total value when there is a verified top competitor with a shipped and sold total value that is lower than the host provider's shipped and sold total value.

Shipped and sold refers to the item origination data associated with a particular item. For example, some providers offer a number of items shipped and sold from that provider, as well as offering a number of other items shipped from the provider but sold from other distributors, such as third-party distributors. As used herein, a provider refers to a retail supplier of goods to consumers, while a distributor refers to an agent or party who supplies goods to stores and other businesses that sell to consumers. As a non-limiting example, Provider-A may purchase goods from Distributor-1 and Distributor-2, and offer them for sale to consumers—these goods may be considered shipped and sold by Provider-A. Provider-A may also contract with Distributor-3 to offer goods supplied by Distributor-3 to consumers via Provider-A—these goods may be considered shipped by Provider-A but sold by Distributor-3.

The RTTMM system includes parameters that factor in the item origination data, the shipped and sold information, for each item in a matching operation in order to calculate per-item differentials and/or generate comparison results or item notifications. In some examples, the parameters may indicate that only items shipped and sold by a target provider are subject to matching operations, while items shipped by a target provider that are sold by a third-party distributor are not subject to matching operations. In other examples, the parameters may include criteria for calculating shipping costs based on delivery addresses and/or on industry standards corresponding to shipping costs. In still other examples, the parameters may include criteria for calculating taxes associated with an item or a cart total based on delivery address associated with the virtual cart. RTTMM system logic calculates taxes based on current regulatory standards, for example.

The targeted query, generated by the RTTMM system using unique item identifiers associated with the individual items in the virtual cart, is used to search the online retail site of the selected target for each of the individual items. The returned query results may include individual URLs for each of the individual items identified as a match on the selected target site. The returned query results are used by the RTTMM system to obtain HTML scripts for each of the URLs associated with individual items on the selected target site item. The HTML scripts are parsed by the RTTMM system to obtain information for any matched items at the target site. For example, a matched item is where the same exact product is offered at both the host provider and the target provider—the same exact product being an identical brand, size, amount, etc. In other words, a matched item is not a substitution item, or an item variety. A 4-oz. bottle of Brand-X Sunscreen in the virtual cart would achieve a match with a 4-oz. bottle of Brand-X Sunscreen at the target provider, but would not achieve a match with a 6-oz. bottle of Brand-X Sunscreen at the target provider, for example.

The RTTMM system parses the obtained HTML scripts to extract a number of item tags. The tags may include item origination tags (shipped and sold tags); item value tags (item price); and additional tags (i.e. promotional tags, membership tags, tax exclusion tags, shipping exception tags, and other specialty tags). The RTTMM system identifies these tags for each item that was in the targeted query, corresponding to the virtual cart, to calculate per-item comparison data and value differentials were applicable, based on set of parameters 134. The comparison results and calculated differentials are used to generate item notifications and optimized cart values, which are output as an updated cart, or optimized cart, to the RTTMM interface.

The optimized cart may also be utilized in a physical store, or brick and mortar store, to adjust a price of an item or set of items, or a cart total, at a point of sale device in-store. For example, a consumer shopping in a physical store may add items to a virtual cart via a mobile user device as they add the same items to a physical cart, in order to obtain a dynamic cart optimization based on a selected target as they shop in-store. The optimized cart represented on the mobile user device may be presented at a physical point of sale device to adjust a value total for a transaction in-store in this example.

The computing device 102 optionally includes a communications interface component 140. In some examples, the communications interface component includes a network interface card and/or computer-executable instructions (e.g., a driver) for operating the network interface card. Communication between the computing device and other devices may occur using any protocol or mechanism over any wired or wireless connection. In some examples, the communications interface is operable with short range communication technologies such as by using near-field communication (NFC) tags.

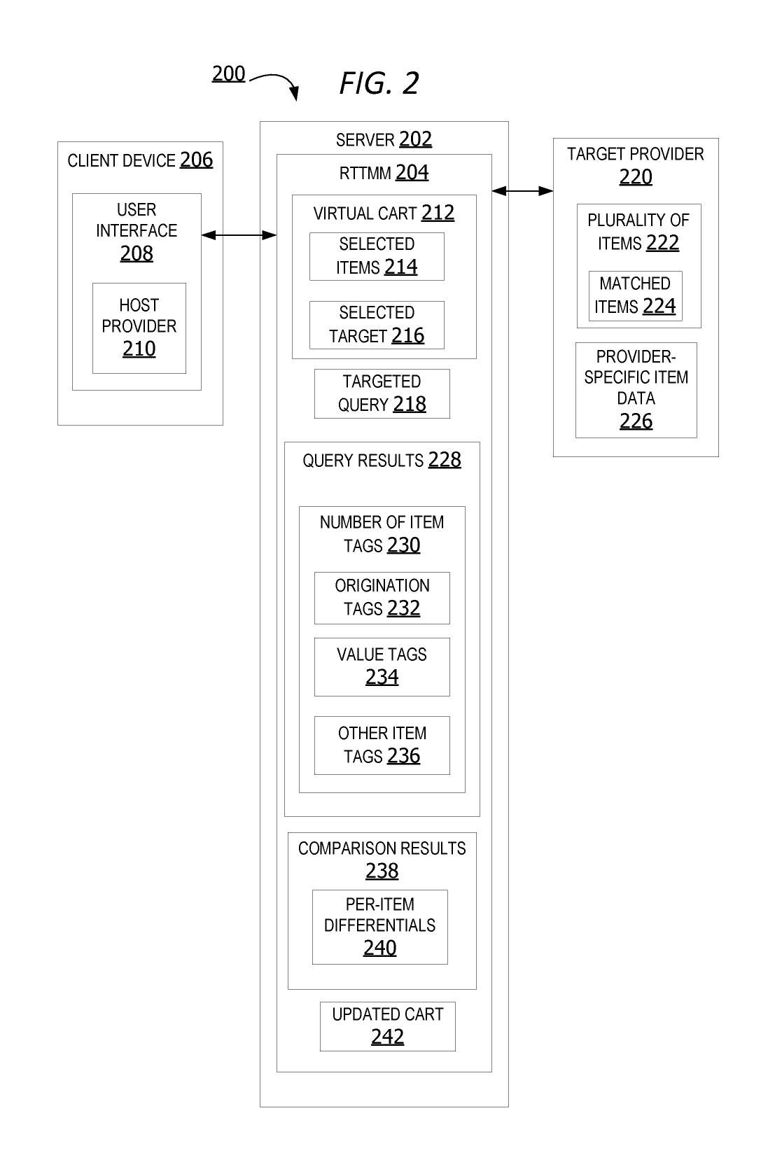

FIG. 2 is an exemplary block diagram illustrating a virtual cart optimization system. The system 200 includes a server 202 for hosting RTTMM 204, such as RTTMM 112 in FIG. 1. RTTMM 204 receives an optimization request from client device 206. Client device 206 may communicate with server 202 via a network, such as network 130 in FIG. 1, for example. Client device 206 may include a user interface 208, which may be an RTTMM interface in some examples. User interface 208 may be associated with host provider 210 in this example. Host provider 210 may be a retail provider of goods, for example, with an online presence for offering goods to consumers.

RTTMM 204 obtains virtual cart 212 from client device 206 via user interaction with user interface 208. Virtual cart 212 includes selected items 214 and selected target 216. Selected items 214 may be one or more items selected from a list of offered items at host provider 210 and added to virtual cart 212 by a user, for example. Selected target 216 may be a target provider, or competitor of host provider 210, selected from a list of pre-defined or pre-verified target providers at user interface 208.

RTTMM 204 uses unique item identifiers associated with selected items 214, along with selected target 216, to generate targeted query 218. Targeted query 218 is provided to a search engine, which may be integrated with RTTMM 204 in some examples, to obtain targeted query results. Targeted query 218 may be directed at target provider 220 in this example. Target provider 220 may offer plurality of items 222, of which matched items 224 may be identified using targeted query 218. Provider-specific item data 226 corresponding to matched items 224 is returned with query results 228 to RTTMM 204.

Query results 228 may be used by RTTMM 204 to obtain HTML scripts specific to each identified item at the target provider 220, and the obtained HTML scripts are parsed by RTTMM 204 to identify number of item tags 230. Number of item tags 230 may include origination tags 232, value tags 234, and other item tags 236, in this example. RTTMM 204 uses the identified number of item tags 230 to generate comparison results 238. Comparison results 238 may include per-item comparison data, including per-item differentials 240 where applicable. Per-item differentials may be calculated with a value tag associated with an individual item indicates a lower value in comparison to a value associated with the individual item in the virtual cart, for example. RTTMM 204 uses comparison results 238 to generate updated cart 242, which may be output to user interface 208 for real-time cart optimization at client device 206.

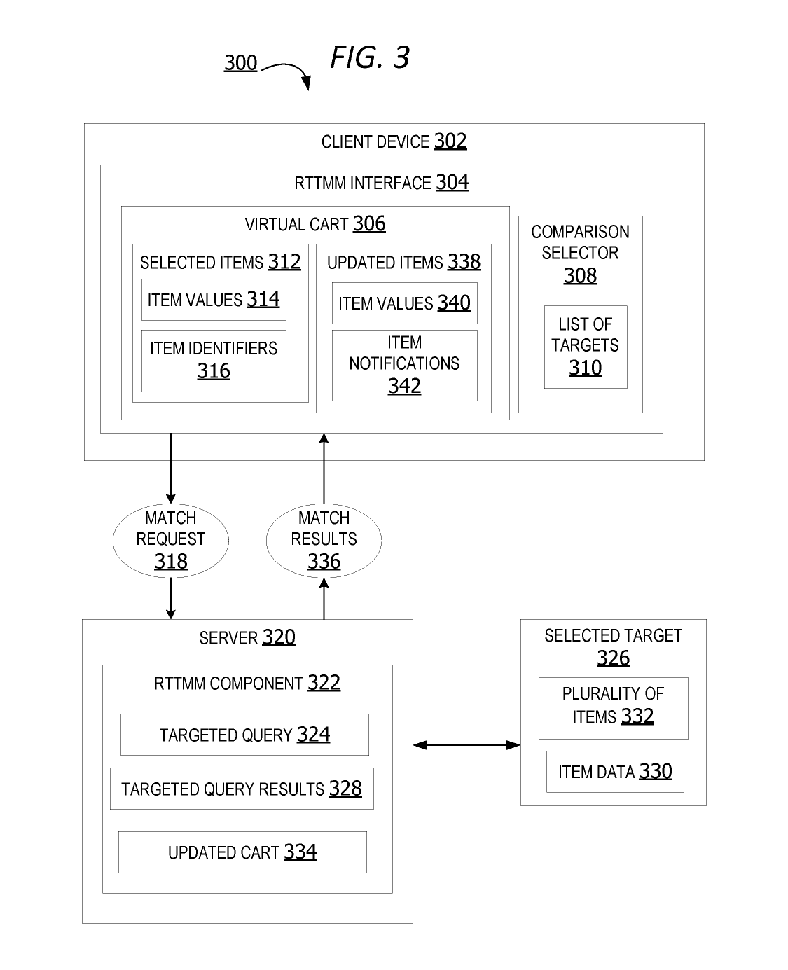

FIG. 3 is an exemplary block diagram illustrating a real-time targeted match system interface. The system interface 300 includes a client device 302. The client device 302 is a computing device, such as client device 122 in FIG. 1 and/or client device 206 in FIG. 2. The RTTMM interface 304 may be implemented on client device 302, in this example, and communicatively coupled to an RTTMM component 322 at server 320 via a network, such as network 130 in FIG. 1.

RTTMM interface 304 includes virtual cart 306. Virtual cart 306 may be a visual representation of item selections made at a host provider site by a user. Virtual cart 306 may be integrated with RTTMM interface 304, in this example. Prior to an optimization operation, virtual cart 306 includes selected items 312. Selected items 312 may include item data, such as item values 314 and item identifiers 316. RTTMM interface also includes comparison selector 308, which may be a targeted match option or targeted comparison option presented at the user interface. Comparison selector 308 includes list of targets 310. The list of targets 310 may include one or more target providers for a comparison and/or match operation.

When a target selection is made from list of targets 310 at comparison selector 308 via RTTMM interface 304, RTTMM interface generates match request 318. Match request 318 may be transmitted from client device 302 to RTTMM component 322 at server 320 for processing. Server 320 may be a computing device, such as computing device 102 in FIG. 1 and/or server 202 in FIG. 2, for example. RTTMM component 322 may be an example of a component, such as RTTMM 112 in FIG. 1 and/or RTTMM 204 in FIG. 2, executed by a processor of server 320.

RTTMM component 322 receives match request 318 and generates targeted query 324 for the selected target 326 using the selected item data from match request 318. The targeted query 324 may provide targeted query results 328, which includes item data 330 for plurality of items 332. Plurality of items 332 may be matched items that correspond to selected items 312, for example. RTTMM component 322 parses the item data 330 of targeted query results 328 to identify a number of item tags used to generate comparison results. RTTMM component 322 generates updated cart 334 based on the generated comparison results and returns updated cart 334 as part of match results 336 to RTTMM interface 304 at client device 302.

RTTMM interface 304 receives match results 336, including the updated cart 334, and updates virtual cart 306 with updated items 338. Updated items 338 may include updated item values 340, item notifications 342, and visual representations of comparison results and value adjustments made to optimize virtual cart 306.

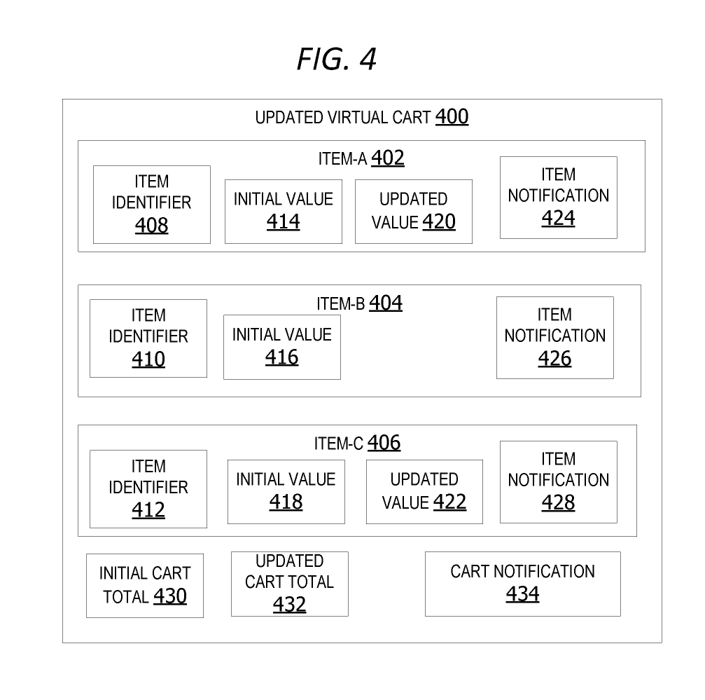

FIG. 4 is an exemplary block diagram illustrating an optimized virtual cart. The updated virtual cart 400 is an example of an optimized cart following a real-time cart match optimization operation by the RTTMM system.

Updated virtual cart 400 may include a number of individual items, such as Item-A 402, Item-B 404, and Item-C 406. Each item in updated virtual cart 400 may include per-item information, such as item identifiers, item values, updated values where applicable, and item notifications, for example. In this illustrative embodiment, Item-A 402 includes item identifier 408, Item-B 404 includes item identifier 410, and Item-C 406 includes item identifier 412. Item identifiers 408, 410, and 412 are unique item identifiers that uniquely identify a specific item—the specific item referring not only to a type of item, but item characteristics as well, such as brand, size, quantity, and the like. For example, Item-A 402 may be a 12-pack case of Brand-Y number-2 pencils, and item identifier 408 may uniquely identify these item characteristics, while a 12-pack case of Brand-Z number-2 pencils may have a different item identifier relative to item identifier 408. In this way, the comparison and match operations may provide precise comparison results.

Each item may also include initial value designations, which may be values corresponding to the individual item at the host provider. For example, Item-A 402 includes initial value 414, Item-B 404 includes initial value 416, and Item-C 406 includes initial value 418. In this example, Item-A 402 includes updated value 420 and Item-C 406 includes updated value 422, while Item-B 404 is without an updated value. Update values, such as updated value 420 and updated value 422, may be a result of a value adjustment to initial values, such as initial value 414 and initial value 418, based on the comparison and match operations, for example. As an illustrative example, the RTTMM system may determine that an item value at the target provider the optimization process is directed towards is different from the initial value associated with the item at the host provider. The RTTMM system calculates per-item differentials based on the targeted query results, and determines whether the differentials are associated with an increase or decrease to the initial value relative to the obtained target value. In other words, if the calculated differential would increase the initial value, the initial value is maintained at the updated virtual cart, such as in the example of Item-B 404. If the calculated differential would decrease the initial value, an updated value that matches the obtained target value is provided at the updated virtual cart, such as in the example of updated values 420, 422. In this way, updated virtual cart 400 is optimized at a per-item level to provide the lowest values for each item between the host provider values and the target provider values on an individual item basis.

In addition to item value information, updated virtual cart 400 may provide item notifications at a per-item level. Item-A 402 may include item notification 424, Item-B 404 may include item notification 426, and Item-C 406 may include item notification 428. Item notifications may be generated by the RTTMM system based on the comparison results generated, and may include information such as item origination data, value adjustment data, maintained value status data, exception data, and the like. For example, item notification 426 may indicate that initial value 416 is maintained for Item-B 404 in updated virtual cart 400 because initial value 416 is a lower value than an obtained target provider value for Item-B 404. In another example, item notification 424 for Item-A 402 may indicate that updated value 420 represents a savings value of a certain amount relative to initial value 414, and other comparison data that factored into the resulting updated value. In a different example, item notification 426 for Item-B 404 may indicate that item-B 404 is not offered by the target provider, and thus no comparison data is available for that targeted match request.

Updated virtual cart 400 may also include initial cart total 430, updated cart total 432, and cart notification 434. Initial cart total 430 may be an aggregated total of initial item values, such as initial value 414, initial value 416, and initial value 418. Updated cart total may be an aggregated total of a combination of updated values and initial values, such as any available updated values following an RTTMM optimization along with any maintained initial values. Cart notification 434 may include information about an aggregate cart effect of the RTTMM optimization, such as an aggregated cart savings calculated based on per-item adjustments, and the like.

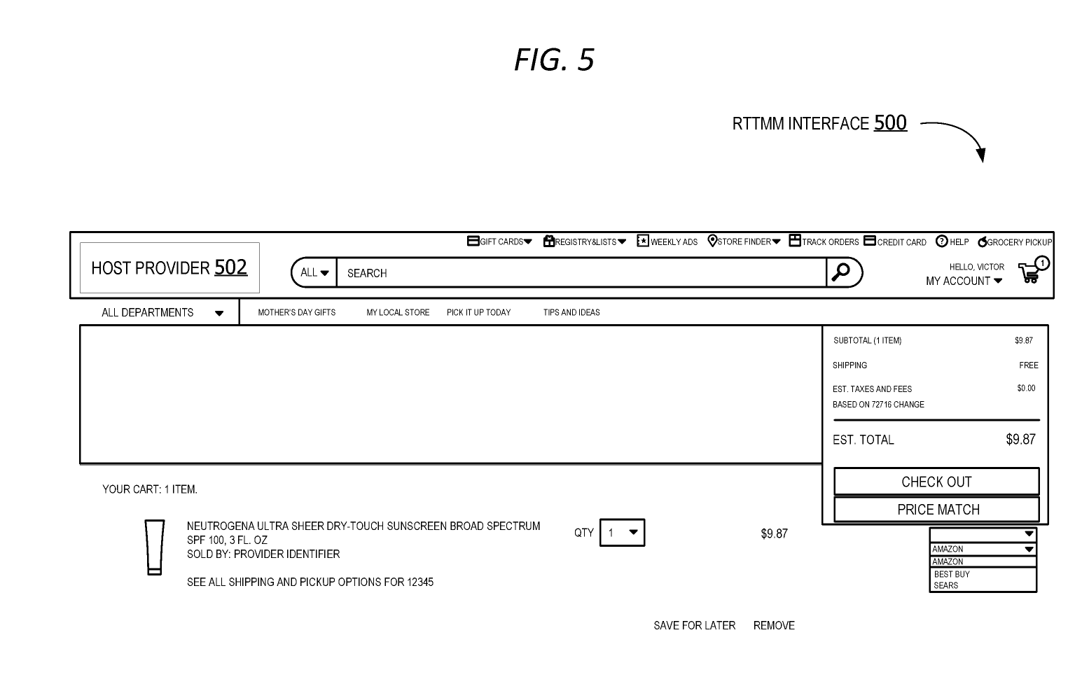

FIG. 5 is an exemplary block diagram illustrating an RTTMM interface. The RTTMM interface 500 in this example may be an illustrative embodiment of RTTMM interface 304 in FIG. 3. The RTTMM interface 500 is integrated with an online site of host provider 502.

The RTTMM interface depicts a selected item that has been added to a virtual cart. The selected item as item-level description information as well as an initial item value corresponding to a selected quantity of the individual item. The virtual cart provides a subtotal, estimated shipping and tax values, and an estimated cart total based on the current status of the cart. The virtual cart also provides a targeted match selection component, or price match button, depicted here as a drop-down menu of pre-defined target providers that may be selected for a cart match operation against the current virtual cart.

In this illustrative example, for brevity of description, one item is depicted in a virtual cart. However, it should be understood that any number of items may be included in the virtual cart, and the systems and processes described herein may execute the same operations for one or many items in a virtual cart, regardless of the number of items.

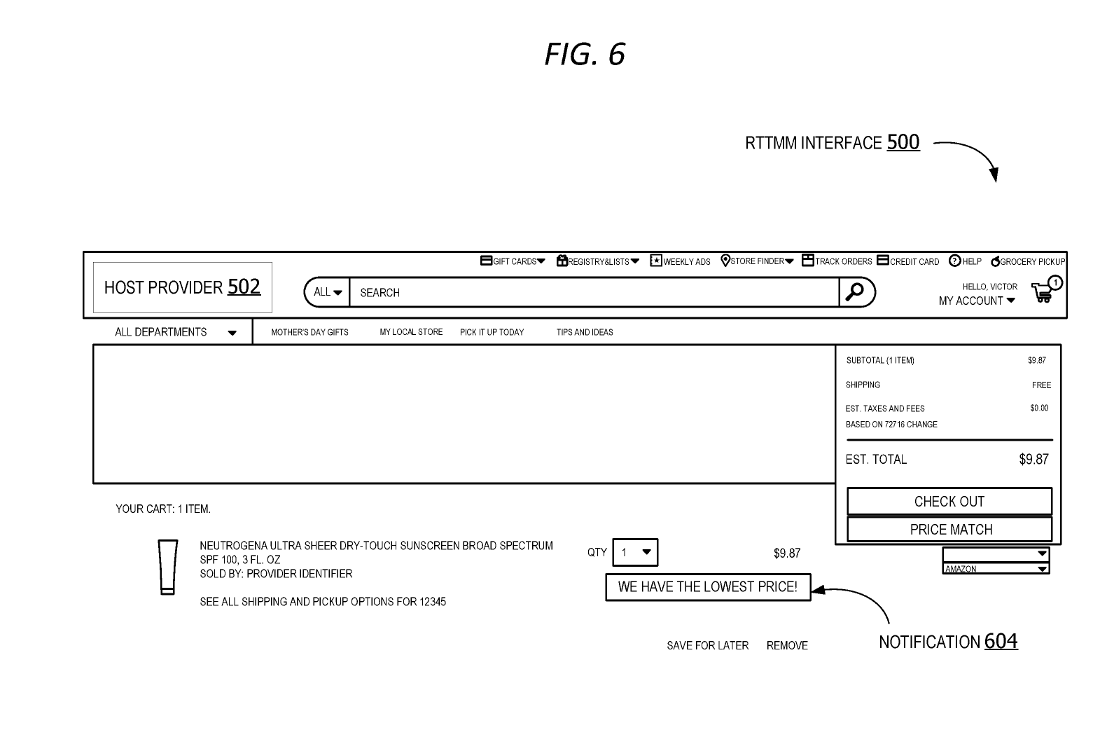

FIG. 6 is an exemplary block diagram illustrating an RTTMM interface displaying an optimized virtual cart. The RTTMM interface 500 in this example depicts an updated virtual cart following an RTTMM cart optimization. Notification 604 is provided at the item-level to indicate that the initial item value has been maintained based on the requested cart match operation because the initial item value is lower than a target provider value for the individual item. The virtual cart provides an updated subtotal, estimated shipping and tax values, and an estimated cart total based on the current updated status of the cart, which in this example is unchanged. The targeted match selection component, or price match button, may depict the selected target that the cart match operation used in the optimization process that resulted in the updated cart.

In this illustrative example, for brevity of description, one item is depicted in a virtual cart. However, it should be understood that any number of items may be included in the virtual cart, and the systems and processes described herein may execute the same operations for one or many items in a virtual cart, regardless of the number of items.

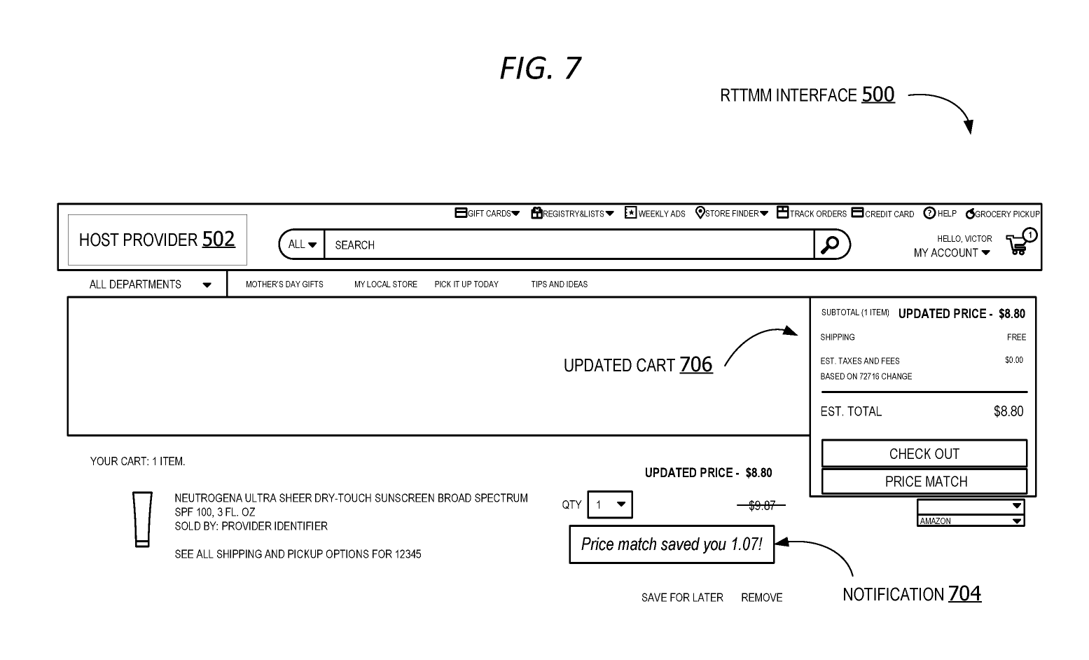

FIG. 7 is an exemplary block diagram illustrating an RTTMM interface displaying an optimized virtual cart. The RTTMM interface 500 in this example depicts an updated virtual cart following an RTTMM cart optimization. Notification 704 is provided at the item-level to indicate that the initial item value has been updated based on the requested cart match operation to reflect a lower value that matches the target provider value for that specific item. In addition, visual representations may be provided that show the initial value and the update value at the per-item level, with the notification providing the calculated differential or other information about the adjustment, for example. The updated cart 706 provides an updated subtotal, estimated shipping and tax values, and an updated estimated cart total based on the current updated status of the cart, which in this example is changed to reflect the lower value matched against the obtained target provider value for the virtual cart items. The targeted match selection component, or price match button, may depict the selected target that the cart match operation used in the optimization process that resulted in the updated cart.

In this illustrative example, for brevity of description, one item is depicted in a virtual cart. However, it should be understood that any number of items may be included in the virtual cart, and the systems and processes described herein may execute the same operations for one or many items in a virtual cart, regardless of the number of items. For example, if the virtual cart included four different items, per-item notifications would be generated for each item as part of the updated cart, and as applicable, per-item value adjustments may be visually represented in the updated cart.

FIG. 8 is an exemplary flow chart illustrating operation of the cart optimization system to generate an updated cart. The process shown in FIG. 8 may be performed by an RTTMM component executing on a computing device, such as, but not limited to, the computing device 102 in FIG. 1, the server 202 in FIG. 2, and/or the server 320 in FIG. 3.

The process begins by receiving a selected target for a cart match operation directed at a current cart at operation 802. The selected target may be identified via user selection of a target provider from a list of target providers via an RTTMM interface at a host provider site, for example. The current cart may be obtained from the RTTMM interface at the host provider site and used to identify one or more items associated with the current cart at operation 804. The one or more items may be items in a virtual cart, added via user selection from a plurality of items provided at the host provider.

The process generates a targeted query for the selected target using the one or more identified items at operation 806. The targeted query may use unique item identifiers associated with each of the one or more identified items to generate a query designed to specifically obtain item information at the selected target for each of the identified items in a single query operation. Query results based on the generated targeted query are received at operation 808. The query results may include HTML scripts from the target provider site, such as individual HTML scripts for each individual item matched between the one or more identified items associated with the current cart and the plurality of items available at the target provider. The matched items may be a subset of items relative to the one or more identified items associated with the current cart. For example, one or more of the identified items may not be offered, or may not be available, at the target provider. The query results may return a null indicator for one or more items that were not matched, for example. Each HTML script in the received query results may correspond to an individual item at the target provider.

The process parses the received query results to identify a number of individual item tags for matched items at operation 810. The matched items may be items that are the same between the one or more items associated with the current cart and items provided by the target provider. For example, an identical product may be a product that is of the same brand, size, quantity, etc. The number of individual item tags may be embedded in the HTML scripts from the target provider, and may be extracted by the RTTMM system to utilize in performing comparison analysis.

At operation 812, the process determines whether an individual item origination is equal to the target provider. In other words, for each individual item or at a per-item level, the RTTMM system determines whether an individual item originates from the target provider or another provider, such as a third-party distributor utilizing the target provider as a pass-through. This may be an example of where a determination is made as to the shipped and sold status for each item.

If the process determines that the individual item does not originate at the target provider—in other words, the target provider may ship the item, but it is sold through the target provider by a third-party—the process generates individual item origination data 814. The individual item origination data may include information as to the origin of the item, information about the item distributor, or any other suitable information that may be used by the RTTMM system to generate an item notification for the individual item in the updated cart.

If the process determines that the individual item does originate at the target provider—in other words, the target provider ships and sells the item—the process identifies an individual target item value at operation 816. The individual target item value may be the item value corresponding to the individual item at the target provider. At operation 818, the process determines whether there are additional matched items to process from the received query results. If the process determines there are additional matched items, the process iteratively returns to operation 812 until all matched items have been processed. If the process determines at operation 818 that there are no additional matched items to process, then the process calculates per-item differentials at operation 820. The per-item differentials are used by the process to generate updated cart at operation 822, which may then be output to a user interface, such as RTTMM interface 304 in FIG. 3, for example.

While the operations illustrated in FIG. 8 are performed by a server or other computing device, aspects of the disclosure contemplate performance of the operations by other entities. For example, a cloud service may perform one or more of the operations.

FIG. 9 is an exemplary flow chart illustrating operation of the cart optimization system to iteratively optimize a virtual cart. The process shown in FIG. 9 may be performed by an RTTMM component executing on a computing device, such as, but not limited to, the computing device 102 in FIG. 1, the server 202 in FIG. 2, and/or the server 320 in FIG. 3.

The process begins by receiving a selected target provider for a cart match operation directed at a host provider cart at operation 902. The process identifies one or more items associated with the host provider cart at operation 904. The process generates a targeted query for the selected target provider using unique item identifiers of the one or more identified items at operation 906. The process transmits the generated targeted query to a search engine at operation 908. The process receives query results based on the generated targeted query from the search engine at operation 910.

The process parses the received query results to identify a number of matched items corresponding to the host provider cart at operation 912. The process identifies a number of individual item tags associated with the number of matched items at operation 914. The process calculates per-item differentials for the number of matched items based on the number of individual item tags at operation 916. The process generates comparison results based on the calculated per-item differentials and the number of individual item tags at operation 918. The process generates an updated cart using the generated comparison results at operation 920. The process then outputs the updated cart to a user interface at operation 922 and may iteratively return to operation 902 based on a user selection of another target provider for another cart match operation, or may terminate thereafter.

While the operations illustrated in FIG. 9 are performed by a server or other computing device, aspects of the disclosure contemplate performance of the operations by other entities. For example, a cloud service may perform one or more of the operations. While the example operations provided herein refer to a suggested or preferred item, a suggested or preferred service may also be identified in a similar manner.

In other examples, a user may add one or more items to a virtual cart during an online shopping session at a host provider site, such as a retail website. The virtual cart interface may include a drop-down menu selection option with one or more pre-selected competitors of the host provider, for user selection to direct towards a targeted cart match operation. A user selection of one of the provider pre-selected competitors becomes the selected target for the cart match operation. The RTTMM logic then generates a targeted query using unique identifiers of each of the individual items in the individual cart to search for those individual items at the selected target provider's online site. The system obtains HTML scripts from the target provider's site for each of the individual items identified at the target provider's site, and the RTTMM logic parses the HTML scripts, or web pages, to identify whether the product is shipped and sold by the target competitor or is provided by a third-party distributor via the target competitor's site. This item origination information may be identified in one or more item tags embedded within the HTML script, for example. The logic then identifies the value, or price, of the item at the target provider's site, using other item tags embedded within the HTML script. For example, the item value tag may be identified in script, such as this illustrative portion:

<span id=”style_name_0_price” class=a-color-price”>

<span class=”a-size-mini”> $14.39 </span>

</span>

In the example above, if the host provider value associated with the same, identical item, differs from the identified value in the item value tag from the host provider site, then the logic calculates a value differential for that individual item, and determines if the differential increases or decreases a value relative to the host provider value for the particular item. If the differential decreases the value, the logic adjusts the price in the virtual cart to match the lower price offered by the target provider, and iteratively performs adjustments and updates as applicable, for each individual item in the virtual cart.

In this example, if the price differential is determined to increase the value of the item relative to the host provider value for a particular item, then the logic generates item notification data, such as an indication that the host provider has the lowest price, or that the current item value reflected in the virtual cart is the lower value relative to the targeted provider value offered on the target provider site. Individual item notifications may provide additional information as well, such as no match for the item in the virtual cart found at the target provider selected, or that the item though available through the target provider site is not shipped and sold by the target provider and is therefore not eligible for an item price-match operation, for example.

In other examples, additional tags identified in the obtained HTML scripts may be factored in, based on a set of parameters, to the cart match operation. For example, shipping value calculations and comparisons may be performed by the system based on obtained shipping value metrics of the target provider and/or associated with the particular items in the virtual cart that are matched at the target provider site. In some examples, the updated cart total may reflect a total that includes aggregated individual item values, tax values, and shipping values, all optimized based on the cart match operations performed by the system, for a total cart optimization.

The RTTMM system provides for efficient price comparison of an entire cart of selected items against a selected target competitor. Rather than providing a single item comparison, such as the item as offered by the host provider compared to the item as offered by one or more other providers, the system described herein enables a price-match comparison of an entire cart of items in one interface instance, in which individual per-item comparison information is provided simultaneously within the virtual cart representation. This improves user interaction and efficiency in online commercial transactions, as well as reduces computing resource usage.

Alternatively, or in addition to the other examples described herein, examples include any combination of the following:
wherein the selected target is selected from a plurality of pre-defined target providers;
iteratively receive another selected target and generate another targeted query for the other selected target using the one or more identified items associated with the current cart;
wherein each item in the one or more identified items includes a corresponding unique item identifier, and wherein the unique item identifier for an individual identified item is used to generate the targeted query;
wherein the received query results include one or more Uniform Resource Locators (URLs) corresponding to the one or more identified items and the selected target;
obtain hyper-text markup language (HTML) scripts of the received query results;
parse the obtained HTML scripts to identify the at least two tags;
parse the obtained HTML scripts to identify additional tags, the additional tags comprising data to be excluded from the cart match operation based on a set of parameters;
wherein the updated cart includes individual per-item indications of adjusted values;
wherein the updated cart includes individual per-item indications of non-adjusted values;
generate a notification based on the generated item origination data and a set of parameters;
wherein the updated cart includes visual representation of at least one of the per-item calculated differentials or the generated notification at a per-item level, and an updated cart value;
iteratively receiving another selected target;
generating another targeted query for the other selected target using the one or more identified items associated with the current cart;
obtaining hyper-text markup language (HTML) scripts of the received query results;
parsing the obtained HTML scripts to identify the at least two tags;
parsing the obtained HTML scripts to identify additional tags, the additional tags comprising data to be excluded from the cart match operation based on a set of parameters.

At least a portion of the functionality of the various elements in FIG. 1, FIG. 2, FIG. 3, FIG. 4, FIG. 5, FIG. 6 and FIG. 7 may be performed by other elements in FIG. 1, FIG. 2, FIG. 3, FIG. 4, FIG. 5, FIG. 6, and FIG. 7 or an entity (e.g., processor, web service, server, application program, computing device, etc.) not shown in FIG. 1, FIG. 2, FIG. 3, FIG. 4, FIG. 5, FIG. 6 and FIG. 7.

In some examples, the operations illustrated in FIG. 8 and FIG. 9 may be implemented as software instructions encoded on a computer-readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for real-time virtual cart optimization. For example, the elements illustrated in FIG. 1, FIG. 2, FIG. 3, FIG. 4, FIG. 5, FIG. 6, and FIG. 7, such as when encoded to perform the operations illustrated in FIG. 8 and FIG. 9, constitute exemplary means for receiving a selected target for a cart match operation directed at a current cart associated with a host provider via an online selection; exemplary means for identifying one or more items associated with the current cart; exemplary means for generating a targeted query for the selected target using the one or more identified items; exemplary means for querying a search engine using the generated targeted query; exemplary means for receiving query results from the search engine, the query results including an individual result for each of the one or more identified items; exemplary means for parsing the received query results to identify at least two tags, the at least two tags including an item origination tag and an item value tag; exemplary means for determining, for each of the one or more identified items, whether the item origination tag identifies the selected target or another target; exemplary means for generating item origination data, responsive to a determination that the item origination tag identifies a target other than the selected target; exemplary means for identifying an item value associated with the item value tag, responsive to a determination that the item origination tag identifies the selected target; exemplary means for calculating a differential on a per-item basis using identified item values of at least a subset of items from the one or more identified items; and exemplary means for generating an updated cart based on the per-item calculated differentials.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for virtual cart optimization, the system comprising:
a memory;
at least one processor communicatively coupled to the memory;
a real-time targeted match module (RTTMM), implemented on the memory and configured for execution by the at least one processor to:
receive a selected target for a cart match operation directed at a current cart associated with a host provider via an online selection;
identify one or more items associated with the current cart;
generate a targeted query for the selected target using the one or more identified items;
query a search engine using the generated targeted query;
receive query results from the search engine, the query results including an individual result for each of the one or more identified items;
parse the received query results to identify at least two tags, the at least two tags including an item origination tag and an item value tag;
for each of the one or more identified items, determine whether the item origination tag identifies the selected target or a target other than the selected target;
responsive to a determination that the item origination tag identifies the target other than the selected target, generate item origination data;
responsive to a determination that the item origination tag identifies the selected target, identify an item value associated with the item value tag;
calculate a differential on a per-item basis using identified item values of at least a subset of items from the one or more identified items;
based on the per-item calculated differentials, generate an updated cart; and
output the generated updated cart to a user interface.

2. The system of claim 1, wherein the selected target is selected from a plurality of pre-defined target providers.

3. The system of claim 1, wherein the RTTMM is further configured to:
iteratively receive another selected target and generate another targeted query for the other selected target using the one or more identified items associated with the current cart.

4. The system of claim 1, wherein each item in the one or more identified items includes a corresponding unique item identifier, and wherein the unique item identifier for an individual identified item is used to generate the targeted query.

5. The system of claim 1, wherein the received query results include one or more Uniform Resource Locators (URLs) corresponding to the one or more identified items and the selected target.

6. The system of claim 1, wherein the RTTMM is further configured to:
obtain hyper-text markup language (HTML) scripts of the received query results; and
parse the obtained HTML scripts to identify the at least two tags.

7. The system of claim 6, wherein the RTTMM is further configured to:
parse the obtained HTML scripts to identify additional tags, the additional tags comprising data to be excluded from the cart match operation based on a set of parameters.

8. The system of claim 1, wherein the updated cart includes individual per-item indications of adjusted values.

9. The system of claim 1, wherein the updated cart includes individual per-item indications of non-adjusted values.

10. The system of claim 1, wherein the RTTMM is further configured to:
generate a notification based on the generated item origination data and a set of parameters.

11. The system of claim 10, wherein the updated cart includes visual representation of at least one of the per-item calculated differentials or the generated notification at a per-item level, and an updated cart value.

12. A computer-implemented method for virtual cart optimization comprising:
receiving, by a real-time targeted match module (RTTMM) implemented on a processor, a selected target for a cart match operation directed at a current cart associated with a host provider via an online selection;
identifying one or more items associated with the current cart;
generating a targeted query for the selected target using the one or more identified items;
querying a search engine using the generated targeted query;
receiving query results from the search engine, the query results including an individual result for each of the one or more identified items;
parsing the received query results to identify at least two tags, the at least two tags including an item origination tag and an item value tag;
for each of the one or more identified items, determining whether the item origination tag identifies the selected target or another target;
responsive to a determination that the item origination tag identifies a target other than the selected target, generating item origination data;
responsive to a determination that the item origination tag identifies the selected target, identifying an item value associated with the item value tag;
calculating a differential on a per-item basis using identified item values of at least a subset of items from the one or more identified items;
based on the per-item calculated differentials, generating an updated cart; and
outputting the generated updated cart to a user interface.

13. The computer-implemented method of claim 12, further comprising:
iteratively receiving another selected target; and
generating another targeted query for the other selected target using the one or more identified items associated with the current cart.

14. The computer-implemented method of claim 12, wherein each item in the one or more identified items includes a corresponding unique item identifier, and wherein the unique item identifier for an individual identified item is used to generate the targeted query.

15. The computer-implemented method of claim 12, further comprising:
obtaining hyper-text markup language (HTML) scripts of the received query results; and
parsing the obtained HTML scripts to identify the at least two tags.

16. The computer-implemented method of claim 15, further comprising:
parsing the obtained HTML scripts to identify additional tags, the additional tags comprising data to be excluded from the cart match operation based on a set of parameters.

17. One or more computer storage devices having computer-executable instructions stored thereon for real-time virtual cart optimization, which, on execution by a computer, cause the computer to perform operations comprising:
receiving, by a real-time targeted match module (RTTMM) implemented on the computer, a selected target for a cart match operation directed at a current cart associated with a host provider via an online selection;
identifying one or more items associated with the current cart;
generating a targeted query for the selected target using the one or more identified items;
querying a search engine using the generated targeted query;
receiving query results from the search engine, the query results including an individual result for each of the one or more identified items;
parsing the received query results to identify at least two tags, the at least two tags including an item origination tag and an item value tag;
for each of the one or more identified items, determining whether the item origination tag identifies the selected target or another target;
responsive to a determination that the item origination tag identifies a target other than the selected target, generating item origination data;
responsive to a determination that the item origination tag identifies the selected target, identifying an item value associated with the item value tag;
calculating a differential on a per-item basis using identified item values of at least a subset of items from the one or more identified items;
based on the per-item calculated differentials, generating an updated cart; and
outputting the generated updated cart to a user interface.

18. The one or more computer storage devices of claim 17, having further operations comprising:
iteratively receiving another selected target; and
generating another targeted query for the other selected target using the one or more identified items associated with the current cart.

19. The one or more computer storage devices of claim 17, wherein each item in the one or more identified items includes a corresponding unique item identifier, and wherein the unique item identifier for an individual identified item is used to generate the targeted query.

20. The one or more computer storage devices of claim 17, having further operations comprising:
obtaining hyper-text markup language (HTML) scripts of the received query results; and
parsing the obtained HTML scripts to identify the at least two tags.
